(19) United States
(12) Patent Application Publication
(10) Pub. No.: US 2014/0149243 A1
(43) Pub. Date: May 29, 2014

(54) VENDOR DOWNLOAD INTEGRATION

(71) Applicant: RED HAT, INC., Raleigh, NC (US)

(72) Inventor: Gerardus Theodorus Jansen, Pedara (IT)

(73) Assignee: RED HAT, INC., Raleigh, NC (US)

(21) Appl. No.: 13/689,510

(22) Filed: Nov. 29, 2012

(51) Int. Cl. G06Q 30/06

(52) U.S. Cl. CPC G06Q 30/0601
USPC 705/26.1

(57) ABSTRACT

System for software vendor integration into an electronic marketplace. An example system receives, via an electronic software marketplace and from a user who is signed in to the electronic software marketplace, a request to download a software application hosted by a software vendor. The example system populates a form request for the software application with information from a user profile associated with the user, and submits the form request to the software vendor such that the user can download the software application directly from the software vendor.

### TECHNICAL FIELD

Embodiments of the present invention relate to software distribution, and more specifically to an electronic software marketplace that provides access to software hosted by independent software vendors.

### BACKGROUND

Electronic software marketplaces have risen in prominence, as demonstrated by the popularity of electronic software marketplaces such as the Apple App Store™, Google Play™, HP webOS App Catalog™, and so forth. These electronic software marketplaces are typically targeted to a particular technology platform, client device type, or set of client device types. Further, in order to streamline the process of downloading and installing software, these electronic software marketplaces ingest software packages and offer these software packages for download to client devices on behalf of software vendors or developers. In this way, the electronic software marketplace manages, on behalf of software vendors, billing, hosting, installation, distribution, software license enforcement, enabling searchability and software discoverability, and so forth. Further, the electronic software marketplace can impose certain restrictions or requirements on software packages so that only approved applications are allowed in to the electronic software marketplace.

This centralized approach brings some benefits, but also brings some downsides. For example, software vendors sacrifice direct control over the software product offered to users. In one alternate approach, the electronic software marketplace serves as a directory of links to independently provided download pages from software vendors. However, this approach can be cumbersome, inelegant, and inconsistent. For example, under this approach a user creates and maintains separate user profiles to download software from different vendors. Further, the user interface and “look and feel” may vary significantly between the electronic software marketplace and the vendor, and especially between vendors. The electronic software marketplace may have little or no control over the quality or authenticity of software packages.

### BRIEF DESCRIPTION OF THE DRAWINGS

The present invention is illustrated by way of example, and not by way of limitation, in the figures of the accompanying drawings and in which:

FIG. 1 illustrates a block diagram of an exemplary computer and network architecture for an electronic marketplace and independent software vendors.

FIG. 2 illustrates a block diagram of an example electronic marketplace in accordance with some embodiments.

FIG. 3 illustrates a first example method embodiment associated with the electronic marketplace.

FIG. 4 illustrates a second example method embodiment associated with an independent software vendor.

FIG. 5 illustrates a third example method embodiment associated with a client device interacting with the electronic marketplace and the independent software vendor.

FIG. 6 illustrates a block diagram of an exemplary computer system, in accordance with one embodiment of the present invention.

### DETAILED DESCRIPTION

Described herein is a system, a method and apparatus for an electronic software marketplace that allows client devices to access and download software packages from independent software vendors. Instead of the existing approach in which the user clicks a “download evaluation version” link on a vendor's site, is redirected to a form to fill out and submit, accepts an End-User License Agreement, and finally downloads the file, embodiments of the invention are more integrated with an electronic software marketplace. In one example embodiment, the electronic software marketplace provides an aggregated list of software available from multiple software vendors for a particular platform, such as an operating system or a mobile device. A user desiring to download software from the electronic software marketplace first creates a user profile with the marketplace, providing personal information such as a user name, password, address, payment information, contact information, demographic information, or other information. The user logs in to the marketplace using the user profile. The user can log in via an on-device marketplace interface or via a web interface, for example. In another variation, the user does not create a user profile or log in in order to browse the marketplace.

Once the user is logged in to the marketplace, the user can browse available software packages. The marketplace does not host the software packages, but may host all or part of a description or an index of the software packages. When the user identifies a software package to obtain, the marketplace can generate an HTTP POST request or a request of any other interaction type for the vendor providing the software package and populate the various fields of the request based on the user's profile or other data provided by the user. The software package can be a full version, a demo version, or some other software. Further, the software package can include not just executable software, but other digital content, such as add-on packs, images, audio, video, metadata, keys that unlock additional functionality in existing software, virtual items or abilities in a game, software libraries, software updates, books, and so forth. The marketplace can also incorporate additional logic or steps to identify requirements associated with the software package, such as end-user license agreements, dependencies, and so forth. The marketplace acts according to the additional requirements, if any, and then submits the request to the vendor. The marketplace and the vendor interact to coordinate how the user will download the software package. For example, the vendor can respond to the HTTP POST request and return a temporary vendor-hosted URL for the software package to the marketplace, to which the marketplace redirects the user. The marketplace and the vendor can communicate using other technologies, such as AJAX or WebSocket.

This download integration provides an integrated approach for users, so that users can obtain software from a single marketplace that uses existing user profile data. As a result, the user does not have to enter the same or similar information for each separate vendor. Further, the tight integration with the marketplace can provide a more unified user experience without the wide variety of user interfaces, color schemes, browser compatibilities, and so forth associated with downloading software from different vendors directly.

From the vendor point of view, integration with the electronic software marketplace has few, if any, differences between a user directly filling out and submitting a form, with the exception that marketplace hosts the form instead of the vendor. In one embodiment, when a user clicks “Download” on a marketplace interface for an application hosted by the vendor, the marketplace performs the following. The marketplace ensures that the user is logged in with a marketplace user account. If the user is not logged on, the marketplace prompts the user to do so. If the user has not created a user account, the marketplace can prompt the user to create an account. The marketplace ensures that the user has opted in or provided some other indication that the marketplace is authorized to share the user's contact details with the vendor. If the user has not opted to share such information as required by the vendor, the user should do so before proceeding to the download. If the download is associated with an end-user license agreement, the marketplace displays the end-user license agreement to the user, and requests the user to acknowledge or accept the agreement. If the user does not acknowledge, the marketplace should not proceed to the download.

In one embodiment, once the prerequisites for the download have been performed, the marketplace generates an HTML <FORM> and prepopulates the fields using relevant user information from the user account, and based on the end-user license agreement. The form's “action” refers to a POST entry point on the vendor web site. The marketplace submits the form to the vendor on behalf of the user. The vendor receives the form data, and can perform various checks on the data. The vendor can store all or part of the information received in the POST as a lead for a later contact for sales, support, feedback or other purposes. Then the vendor serves the download to the user.

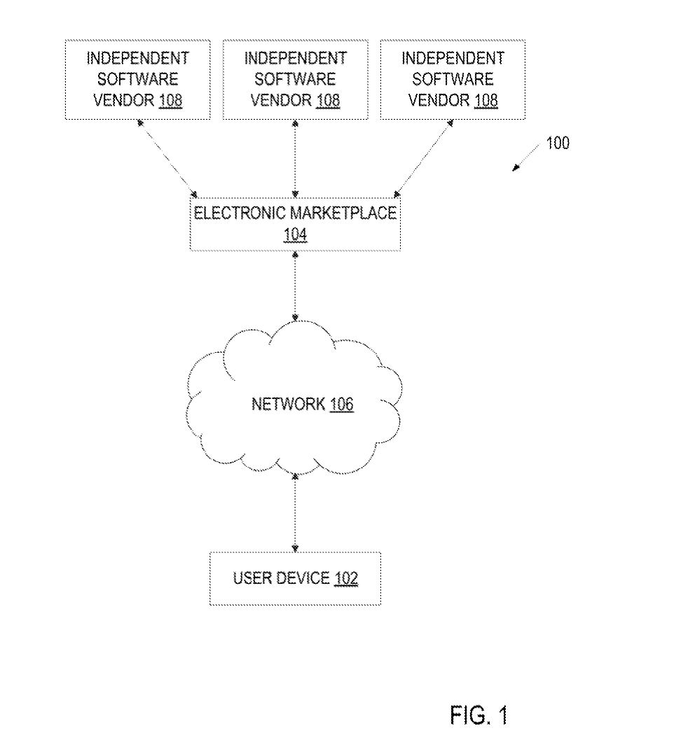

FIG. 1 is a block diagram of exemplary architecture 100 for an electronic marketplace according to embodiments of the invention. The architecture 100 includes a user device 102.

As shown in FIG. 1, the user device 102 is communicatively connected to an electronic marketplace 104 via a communication network 106, such as the Internet, an intranet, or other network(s). The electronic marketplace 104 communicates with various independent software vendors 108. The user device 102 and the electronic marketplace 104 can communicate with the independent software vendors 108 via the network 106 or via one or more other networks, not shown.

An independent software vendor 108 refers to a system that offers various software for download, whether through the electronic marketplace 104 or independently of the electronic marketplace. An independent software vendor 108 can be an entity that authors software, such as a software development company or group, or can be an entity that simply distributes software produced by others, such as a distributor. Independent software vendors may have different requirements for users to download software, can use different software formats, different software delivery mechanisms, and so forth. The electronic marketplace 104 refers to a system that provides a central location for users and/or devices to obtain software. In one embodiment of a mobile device, the mobile device may be restricted to installing software only through the electronic marketplace. However, in other embodiments, the electronic marketplace provides a convenient way to install software on the device, but not necessarily the only way. In various embodiments, the electronic marketplace provides an interface for users to search, browse, read reviews, leave feedback, research, download, install, purchase, and perform other actions relating to software applications. The electronic marketplace 104 can communicate with the independent software vendors to index the available software packages, as well as any supporting information such as end-user license agreements, target system requirements, permissions, metadata, key words, price, evaluation terms, and so forth. Then, when the user device 102 queries or browses the electronic marketplace 104 for software packages, the electronic marketplace 104 can use indexed information instead of each time querying the independent software vendors 108. The user device 102 and the electronic marketplace 104 interact with each other, and based on those interactions, the electronic marketplace 104 automatically generates and populates a request (e.g., a HTML FORM request) for a software package, without necessarily displaying the form to the user, without the user actively filling out a web based form, and potentially without the user's knowledge that a request (e.g., a FORM) is being generated and submitted. Then the electronic marketplace 104 submits the request (e.g., FORM request) to the appropriate independent software vendor 108, and arranges for the user device 102 or other target device (not shown) associated with the user device 102 to download the software package from that independent software vendor 108.

One having ordinary skill in the art will appreciate that the user device can be any type of computing device such as, for example, a desktop computer, a portable digital assistant, a mobile phone, a laptop computer, a portable media player, a tablet computer, a netbook, a notebook, a personal computer, kiosk, set-top box, integrated computing device, a point of sale device, a hand-held device, and so forth.

In an embodiment, the electronic marketplace 104 is a server computing device including a central processing unit (CPU) and memory. The memory may be configured to store instructions or a software package for the electronic marketplace, any electronic marketplace subsystems, and so forth. In an embodiment, the electronic marketplace 104 is a web server that provides a web-based marketplace interface for user devices 102, however the electronic marketplace 104 can provide other non-web network interactions with the user device 102, such as network interactions for populating or controlling a locally installed marketplace interface application on the user device 102.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “populating”, “submitting”, “confirming”, “storing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

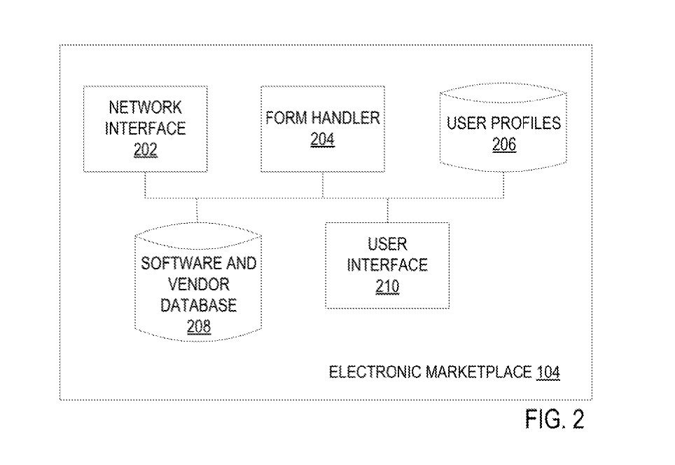

FIG. 2 illustrates a block diagram of an example electronic marketplace 104. The electronic marketplace 104 includes a network interface 202, a form handler 204, a collection of user profiles 206, a software and vendor database 208, and a user interface 210. The form handler 204 can identify a form format and other form details for submitting to a particular vendor, and populate the form using data from the user profiles 206. The software and vendor database 208 can include data such as the address to which to POST the populated form, for example. Upon completing a form, the form handler 204 submits the form, via the network interface, to the vendor.

One having ordinary skill in the art will appreciate that the associations between the connections and the subsystems shown in FIG. 2 are presented merely for illustration purposes, and that the connections are not necessarily dedicated to particular user devices. The electronic marketplace 104 may be any software program, process, thread, or daemon executable by a processing device to process information received from one or more problem reporting subsystems. One having ordinary skill in the art will appreciate that the processing device may be multiple computing devices communicatively connected and configured to execute and manage the modules and devices shown in FIG. 1.

In an embodiment, the software and vendor database 208 indicates an HTTP entry point made available by each vendor. An HTTP entry point is a web address through which a client can download software applications. For example, a particular web address, when passed a particular set of arguments in a POST request, may provide the corresponding software application. The electronic marketplace 104 redirects a user to this entry point when that user tries to download the vendor's software. The entry point can be a form entry point, for example. The entry point can respond to an HTTP POST method. The entry point can be accessible from the public internet or from some other network in common with the electronic marketplace 104 and the vendor. For security, the entry point can be available via secure sockets layer (SSL), and the certificate used for the SSL handshake can be signed by one of the main public certificate authorities. For security, the entry point, while accessible from the public internet, may optionally incorporate the “expires” and “signature” fields or other mechanisms to authenticate the request and restrict access to only users of the electronic marketplace 104. In one embodiment, the software vendor provides the form entry point via a content management system of the electronic software marketplace. Then electronic software marketplace creates the form and submits the form via HTTP POST to the provided form entry point. A server operating the form entry point can perform various checks, and can either provide the file directly to the user's device, or can redirect the user to an external location where the user can download the file. The external location may be a link that is only valid for a limited duration.

The form handler 204 identifies a number of data fields that are part of the POST request format for a particular vendor. The data fields can be encoded as “application/x-www-form-urlencoded”, for example. Field values can be UTF-8 encoded text or data in some other format as prescribed or expected by the vendor. The fields that are available are described in the example fields table below. The example fields table shows one example of fields that a vendor may expect to receive in a POST request.

Example Fields Table

| Field | Optional? | Description | Example |
|---|---|---|---|
| company | YES | The company this person works | “Bob's Pizza” |
| | | for. | |
| title | YES | Job title of person at his company. | “Manager” |
| greeting | | The greeting, e.g. “Mr”, “Ms”, | “Mr.” |
| | | etc. | |
| first_name | | The user's first name | “John” |
| last_name | | The user's last name | “Doe” |
| address1 | | Address, line 1 | “200 Main Street” |
| address2 | YES | Address, line 2 | “Second Floor” |
| address3 | YES | Address, line 3 | “Suite 200” |
| city | | The city | “New York” |
| country | | The country | “United States” |
| state | YES | The state | “NY” |
| postal_code | | The postal code | “90210” |
| phone_number | | Primary phone number | “+1 415 123 4567” |
| fax_number | YES | Fax number | “+1 415 123 4567” |
| email | | The email address | bob@bobspizza.com |
| eula | YES | The text of the EULA related to | The full English text of |
| | | this download.. | the EULA. |
| eula_accepted | YES | Whether or not this EULA was | “true” |
| | | accepted. Can be a Boolean | |
| | | “true” or “false” value. | |
| file | | The name of the file that is requested. | “application.ovf” |
| expires | | Date the signature expires, in | “1320868215” |
| | | seconds since midnight, Jan 1st, | |
| | | 1970. See discussion of authentication | |
| | | below. | |
| signature | | A digital signature for this request. | “DK9kn+7klT2Hv5A6 |
| | | See discussion of authentication | wRdsReAo3xY=” |
| | | below. | |

If the download is allowed, the requested file can be served directly in the response to the POST request, without any intermediary HTML pages. If the download is not allowed, the vendor can return to the electronic marketplace 104 a suitable error code, such as 403 Forbidden, and can include an HTML page explaining the error. The marketplace can pass that error code directly to a user, or can parse the HTML page or the error code to understand the error and generate its own message to display to the user based on that information. In another implementation, the system is unable to shown HTML page after a form is submitted in the background due to security checks made in the browser, such as the Same Origin Policy. Instead the system can communicate the error back into the main page via Javascript.

The electronic marketplace 104 or the vendor can optionally implement authentication. In one embodiment, the vendor side entry point can authenticate that the request comes from the electronic marketplace. The vendor can authenticate the electronic marketplace using “signature” and “expires” headers. Example signature values are set forth below:

signature=BASE64(HMAC-SHA1(secret, canonical-form-fields))

The “secret” can be a shared secret between the electronic marketplace 104 and the vendor, and can be made available via the electronic marketplace 104. The electronic marketplace 104 can incorporate a different secret for each vendor or for each group of vendors. The canonical-form-fields can be a serialization of the POSTed form fields. In one example embodiment, the canonical-form-fields are generated by constructing the string “name=value\n” for each field in the “Fields” section except “signature”. The term “name” is the name of the respective field, with “value” being the corresponding value, and “\n” the newline separator or other separator, such as a tab or a comma. For example, using information from the Example Fields Table above, parts of the canonical-form-fields can include “title=Manager\n”, “first_name=John\n”, and “last_name=Doe\n”. After assembling these strings, the electronic marketplace 104 can sort the strings alphabetically or in any other order and concatenate them. The specific order of how strings are concatenated and which strings are concatenated may vary from vendor to vendor.

The electronic marketplace can set the “expires” field to an integer representing the number of seconds since the Unix epoch when this signature will expire, for example. Alternately, the “expires” field can be represented by some other time and date format. The electronic marketplace can then calculate the signature and incorporate the signature into the POST data.

The POST handler on the vendor side calculates the signature independently using the provided fields. The vendor can authenticate the signature as valid if the calculated signature is identical to the signature received from the electronic marketplace, and if the current time is less than the value of the “expires” field, indicating that the signature is not expired.

The “signature” field can be encoded using base64 encoding. A base64 encoded string may contain spaces and newlines as padding. These characters can be ignored when testing a signature. The test vector, as shown in the table below, can be used to test an implementation. The test vector table provides an example of test vectors for a cryptographic protocol, in this case for generating signatures. Entities who implement this cryptographic protocol, such as software vendors, can test their implementation offline before integrating their implementations with the Marketplace in a production environment or an online environment. While this table shows an example test vector table, multiple different test vectors can be used to test for various use cases, for various functionality, and so forth.

Test Vector Table

| Item | Value |
|---|---|
| Fields | address1=200 Main Street |
| | city=New York City |
| | country=United States |
| | email=john@email.com |
| | expires=1321434756 |
| | file=appliance.ovf |
| | first_name=John |
| | greeting=Mr. |
| | last_name=Doe |
| | phone_number=212 123-4567 |
| | postal_code=10001 |
| Secret | secret |
| Signature | En78jN2czBDNp/QJDyTUTryJCFc= |
| POST | greeting=Mr.&first_name=John&last_name=Doe&address1= |
| body | 200% 20Main%20Street&city= |
| | New%20York%20City&country=United |
| | %20States&postal_code=10001&phone_number= |
| | 212%20123-4567&email=john |
| | %40email.com&file=appliance.ovf&expires= |
| | 1321434756&signature= |
| | En78jN2czBDNp%2FQJDyTUTryJCFc%3D |

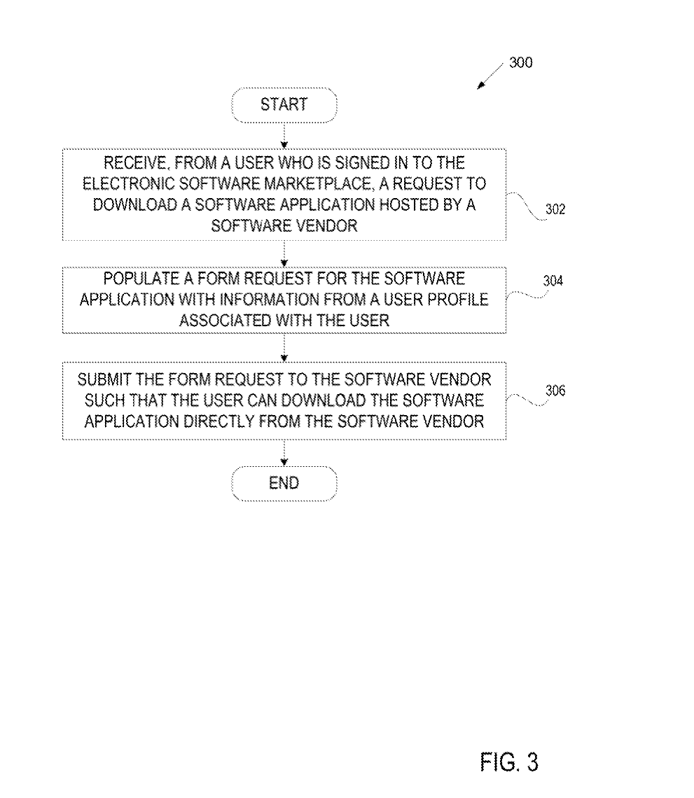

FIG. 3 illustrates a flow diagram of one embodiment of a method 300 for integrating software vendors into an electronic software marketplace from the perspective of the electronic software marketplace. The method 300 is performed by processing logic that may comprise hardware (circuitry, dedicated logic, etc.), software (such as is run on a general purpose computer system or a dedicated machine), or a combination of both. In one embodiment, the method is performed by an electronic software marketplace (e.g., an electronic software marketplace 104 of FIG. 1).

The example electronic software marketplace receives, from a user who is signed in to the electronic software marketplace, a request to download a software application hosted by a software vendor (302). The electronic software marketplace can indicate the software vendor to a client device of the user, but can withhold that information from being presented to the user. The electronic software marketplace can either prompt the user to create a profile, or can automatically create all or part of a user profile for users who do not have profiles, based on input from the user, to allow the user to obtain access to the electronic software marketplace. This can be part of a marketplace registration operation prior to allowing the user to browse or download software applications.

The example electronic marketplace populates a form request for the software application with information from a user profile associated with the user (304). The marketplace can identify an end-user license agreement associated with the software application, such as via a database of end-user license agreements, or via an indication from a software vendor. Then the electronic marketplace can display the end-user license agreement to the user, receive an indication of acceptance of the end-user license agreement from the user, and incorporate the indication of acceptance in the form request. Prior to submitting the form request, the marketplace can confirm that the user has opted in to sharing information with the software vendor.

The example electronic marketplace submits the form request to the software vendor such that the user can download the software application directly from the software vendor (306). The form request can be an HTTP POST request. The marketplace can receive a network address, such as a URL, IP address, and so forth, to download the software application from the software vendor, and redirect the user to the network address. In one embodiment, once the electronic marketplace submits the form request on behalf of the user, all later communications between the user and the software vendor is separate from the electronic marketplace. For example, the electronic marketplace is not directly aware of whether a download succeeded, whether a download failed, where the download is being served from, and so forth. However, even though the electronic marketplace is not participating in the additional communications, the electronic marketplace can obtain this information through a side channel, such as from the software vendor, for statistical, reporting, customer satisfaction evaluation, or other purposes.

The marketplace can gather feedback from users regarding the software application, such as user reviews or user ratings of downloaded software applications. The marketplace can provide those reviews or ratings to the vendor as individual or aggregate feedback.

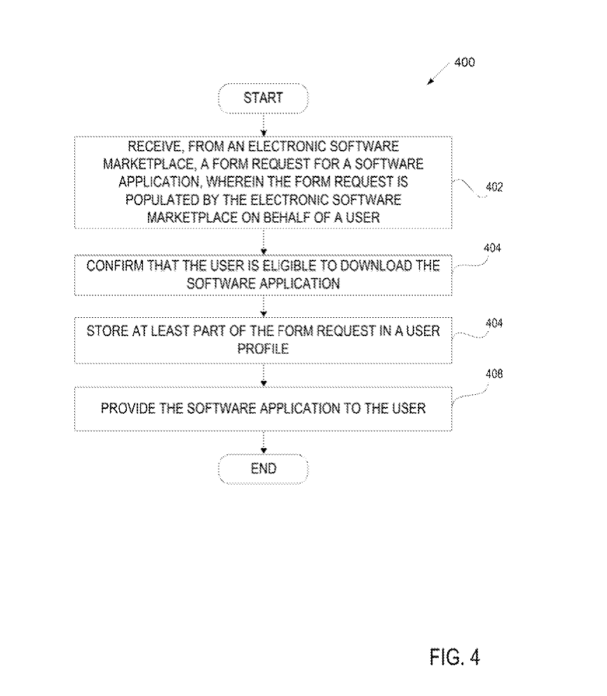

FIG. 4 illustrates a flow diagram of one embodiment of a method 400 for integrating software vendors into an electronic software marketplace from the perspective of the independent software vendor. The method 400 is performed by processing logic that may comprise hardware (circuitry, dedicated logic, etc.), software (such as is run on a general purpose computer system or a dedicated machine), or a combination of both. In one embodiment, the method is performed by an independent software vendor (e.g., an independent software vendor 108 of FIG. 1).

The example independent software vendor receives, from an electronic software marketplace, a form request for a software application, wherein the form request is populated by the electronic software marketplace on behalf of a user (402). The vendor can transmit to the electronic software marketplace a list of required information for downloading the software application. The marketplace can then build and maintain a list of required information for each software application for each vendor. The required information can be consistent on a per-vendor basis, or can vary for each different software application. The required information can change from time to time, as various policies and procedures change. In one embodiment, after the form request is submitted, the electronic software marketplace can only communicate directly with the user. In this embodiment, the system can map dependencies by allowing the software vendor to define dependencies via a content management system or equivalent system associated with the electronic software marketplace.

The vendor confirms that the user is eligible to download the software application (404). The vendor can use the authentication scheme set forth above, or can rely on other authentication. The vendor can optionally rely on the marketplace to determine that the user is eligible, and can trust all requests originating from the marketplace. User eligibility can rely on attributes of the user or of a user device. Further, eligibility can depend on confirmation that the user agreed to an end-user license agreement associated with the software application or other actions by the user.

The vendor stores at least part of the form request in a user profile (406). For example, the vendor can build up a database of users who have downloaded the software application for technical support purposes, for statistical and tracking purposes, or for generating potential sales leads for users that are likely candidates for a later sale of an upgraded version of the software application, a related software application, or an associated service. The user profile can be tied to the user, or can be part of an anonymized and aggregated description of users downloading that particular software package. The vendor may also track which of these users are repeat downloaders, which ones reach out for technical support, what kinds of problems a particular group of users or device types encounter, and so forth.

The vendor provides the software application to the user (408). For example, the vendor can provide a temporary download link for the software application to the electronic software marketplace, which passes the temporary download link to the user. The electronic software marketplace can then redirect the user to the temporary download link or can otherwise initiated the download for the user based on the temporary download link.

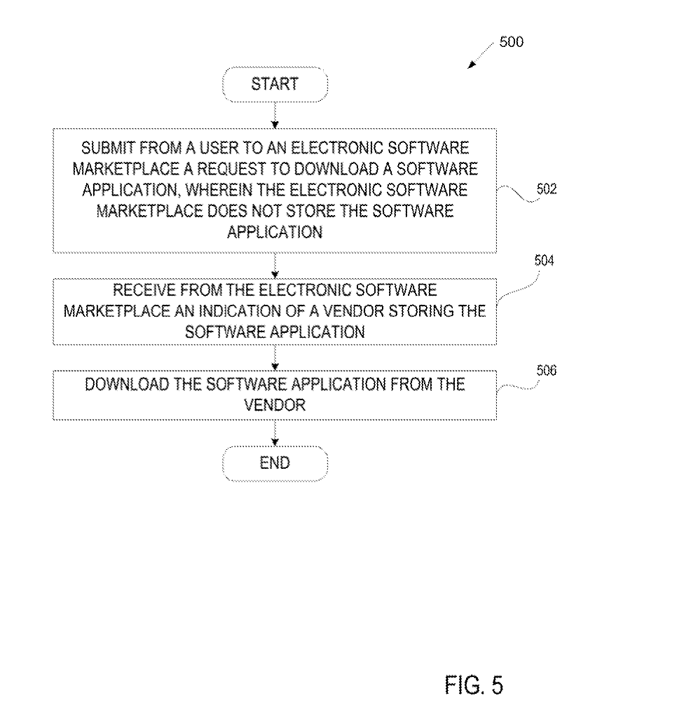

FIG. 5 illustrates a flow diagram of one embodiment of a method 500 for integrating software vendors into an electronic software marketplace from the perspective of the client device. The method 500 is performed by processing logic that may comprise hardware (circuitry, dedicated logic, etc.), software (such as is run on a general purpose computer system or a dedicated machine), or a combination of both. In one embodiment, the method is performed by a client device (e.g., a user device 102 of FIG. 1).

The example client device submits from a user to an electronic software marketplace a request to download a software application, wherein the electronic software marketplace does not store the software application (502). The user can sign in to the electronic software marketplace with a user profile, or can create a new user profile. The user profile can include preferences indicating to the electronic software marketplace that the user agrees to share certain information in the user profile with vendors in association with downloading software applications. Further, the marketplace can share portions of the user profile with vendors for other reasons.

The client device can receive from the electronic software marketplace supplemental conditions associated with the software application, and obtain from the user an agreement to the supplemental conditions. Then the client device can confirm the agreement to the electronic software marketplace. For example, the supplemental conditions can relate to software export agreements, end-user license agreements, age restrictions, non-disclosure agreements, open source licenses, acceptance of supplemental terms, and so forth.

The client device receives from the electronic software marketplace an indication of a vendor storing the software application (504). The indication of the vendor can include a textual description of the vendor, a support website for the vendor, contact information, metadata, rankings, a reputation score, a network address, an image, or other multimedia data. The client device downloads the software application from the vendor (506). In one embodiment, the vendor provides a link to the user to download the software application. The link can be valid for a limited duration. The client device can download the software application from the vendor via an SSL-based connection or other secure channel. The link can be valid only for the client device.

The client device can download software via a separate software component, such as a dedicated client application for interfacing with the electronic software marketplace. However, the client device can alternately interface with the electronic software marketplace via a more general-purpose software tool, such as a web browser. The electronic software marketplace can execute entirely on a server device, or can execute partially on a server and partially on the client device.

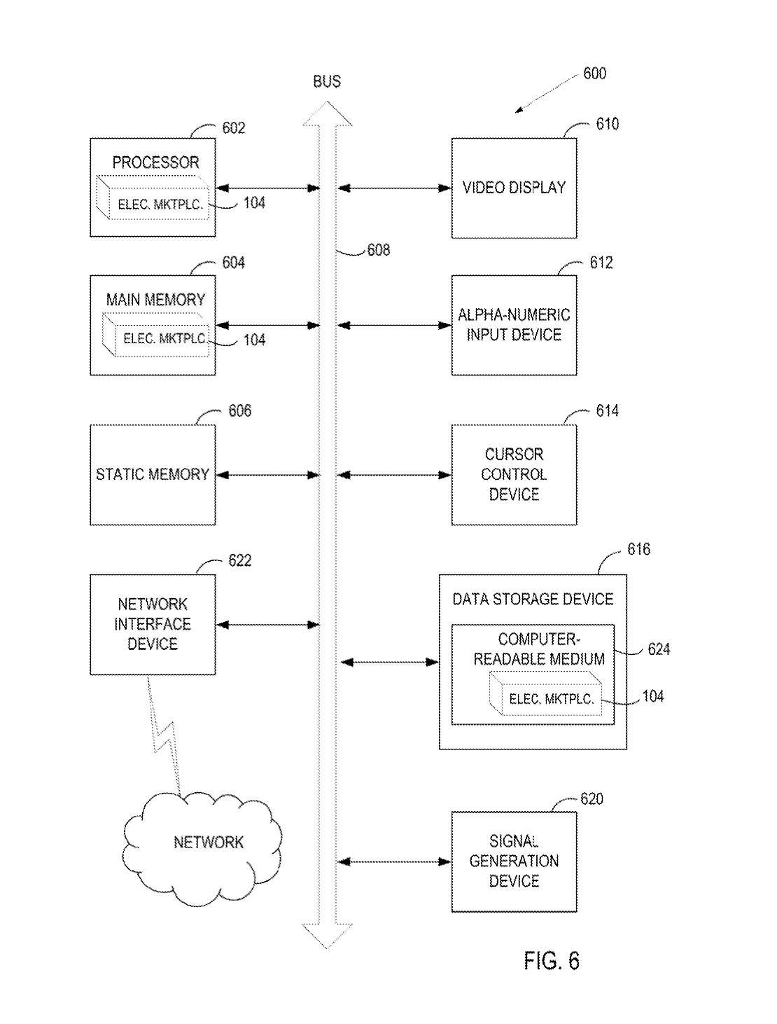

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a secondary memory 618 (e.g., a data storage device), which communicate with each other via a bus 608.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute processing logic (e.g., instructions for an electronic marketplace 104) for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), other user input device such as a touch screen or a microphone, and a signal generation device 620 (e.g., a speaker).

The secondary memory 618 may include a machine-readable storage medium (or more specifically a computer-readable storage medium) 624 on which is stored one or more sets of instructions for the electronic marketplace 104 embodying any one or more of the methodologies or functions described herein. The instructions 626 may also reside, completely or at least partially, within the main memory 604 or within the processing device 602 during execution thereof by the computer system 600, the main memory 604 and the processing device 602 also constituting machine-readable storage media.

The computer-readable storage medium 624 may also be used to store a problem resolution manager which may correspond to the electronic marketplace 104 of FIG. 1), or a software library containing methods that call a electronic marketplace 104. While the computer-readable storage medium 624 is shown in an exemplary embodiment to be a single medium, the term “computer-readable storage medium” should be taken to include a single medium or multiple media (e.g., a centralized or distributed database, or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
receiving, via an electronic software marketplace and from a user who is signed in to the electronic software marketplace, a request to download a software application hosted by a software vendor;
populating, via a processing device, a form request for the software application with information from a user profile associated with the user; and
submitting the form request to the software vendor to enable the user to obtain the software application from the software vendor.

2. The method of claim 1, further comprising:
identifying an end-user license agreement associated with the software application;
presenting the end-user license agreement to the user;
receiving an indication of acceptance of the end-user license agreement from the user; and
incorporating the indication of acceptance in the form request.

3. The method of claim 1, further comprising:
prior to submitting the form request, confirming that the user has opted in to sharing information with the software vendor.

4. The method of claim 1, further comprising:
indicating the software vendor to the user.

5. The method of claim 1, further comprising:
creating the user profile, based on input from the user, to obtain access to the electronic software marketplace.

6. The method of claim 1, wherein the form request is an HTTP POST request.

7. The method of claim 1, further comprising:
receiving a form entry point to download the software application from the software vendor; and
redirecting the user to the form entry point.

8. A system comprising:
a processing device;
a memory storing instructions which, when executed by the processing device, cause the processing device to:
receive, from an electronic software marketplace, a form request for a software application, wherein the form request is populated by the electronic software marketplace on behalf of a user;
confirm that the user is eligible to download the software application;
store at least part of the form request in a user profile; and
provide the software application to the user.

9. The system of claim 8, wherein the instructions, when executed by the processing device, further cause the processing device to:
receive confirmation that the user agreed to an end-user license agreement associated with the software application.

10. The system of claim 8, wherein the instructions, when executed by the processing device, further cause the processing device to:
provide a form entry point to the electronic software marketplace, wherein the form entry point receives user information from the populated form request generated on behalf of the user by the electronic software marketplace, and wherein the form entry point responds with a download of the software application.

11. The system of claim 10, wherein the download of the software application is provided immediately to the user or via a temporary download link accessible by the user.

12. The system of claim 8, wherein the instructions, when executed by the processing device, further cause the processing device to:
identify a likelihood that the user is a candidate for a sale; and
store at least part of the form request as a sales lead.

13. The system of claim 8, wherein the instructions, when executed by the processing device, further cause the processing device to:
transmit to the electronic software marketplace a list of required information for downloading the software application.

14. The system of claim 8, wherein the instructions, when executed by the processing device, further cause the processing device to:
maintain download statistics for the software application.

15. A non-transitory computer-readable storage medium having stored therein instructions which, when executed by a computing device, cause the computing device to perform steps comprising:
submitting from a user to an electronic software marketplace a request to download a software application, wherein the electronic software marketplace does not store the software application;
receiving from the electronic software marketplace an indication of a vendor storing the software application; and
downloading the software application from the vendor.

16. The non-transitory computer-readable storage medium of claim 15, wherein the instructions, when executed by the computing device, further cause the computing device to perform a method comprising:
signing in to the electronic software marketplace with a user profile.

17. The non-transitory computer-readable storage medium of claim 16, wherein the instructions, when executed by the computing device, further cause the computing device to perform a method comprising:
indicating to the electronic software marketplace that the user agrees to share information in the user profile with vendors.

18. The non-transitory computer-readable storage medium of claim 15, wherein the instructions, when executed by the computing device, further cause the computing device to perform a method comprising:
receiving from the electronic software marketplace supplemental conditions associated with the software application;
obtaining from the user an agreement to the supplemental conditions; and
confirming the agreement to the electronic software marketplace.

19. The non-transitory computer-readable storage medium of claim 15, wherein the vendor provides a link to the user to download the software application, wherein the link is valid for a limited duration.

20. The non-transitory computer-readable storage medium of claim 15, wherein the instructions, when executed by the computing device, further cause the computing device to perform a method comprising:
downloading the software application from the vendor via an SSL-based connection.
